(19) United States
(12) Patent Application Publication
(10) Pub. No.: US 2024/0270957 A1
(43) Pub. Date: Aug. 15, 2024

(54) MELAMINE-FORMALDEHYDE RESIN COMPOSITION, COATING COMPOSITION COMPRISING THE SAME, COATING LAYER, AND ITS APPLICATION

(71) Applicant: Chang Chun Plastics Co., Ltd., Taipei City (TW)

(72) Inventors: PIN-CHENG LIN, Taipei City (TW); I-Chiang LAI, Taipei City (TW)

(21) Appl. No.: 18/143,622

(22) Filed: May 5, 2023

(30) Foreign Application Priority Data
Feb. 9, 2023 (CN) 202310088138.0
Feb. 9, 2023 (TW) 112104635

(51) Int. Cl. C08L 61/28; C08J 7/046; C09D 161/28

(52) U.S. Cl. CPC C08L 61/28; C08J 7/046; C09D 161/28; C08J 2361/28

(57) ABSTRACT

Provided is a melamine-formaldehyde resin composition, in a Fourier transform infrared (FT-IR) spectrum of the melamine-formaldehyde resin composition, the melamine-formaldehyde resin composition has a first peak at 3334 cm⁻¹ to 3344 cm⁻¹ and a second peak at 1072 cm⁻¹ to 1074 cm⁻¹, and a ratio of an intensity of the first peak to an intensity of the second peak is less than or equal to 0.021. In addition, the provided further discloses a coating composition, coating layer, and its application. By controlling the ratio of the intensity of the first peak and the intensity of the second peak, the provided enables the coating layer to possess excellent gloss, outstanding chemical resistance, appropriate hardness, and good adhesion, thereby improving the overall performance of the coating and the application products.

### CROSS-REFERENCE TO RELATED APPLICATION

Pursuant to 35 U.S.C. § 119(a), this application claims the benefit of the priority to Taiwan Patent Application No. 112104635 filed on Feb. 9, 2023, and the priority to China Patent Application No. 202310088138.0 filed on Feb. 9, 2023. The contents of the prior applications are incorporated herein by its entirety.

### BACKGROUND OF THE INVENTION

### 1. Field of the Invention

The instant disclosure relates to a resin composition, a coating composition, a coating layer, and its application, particularly to a melamine-formaldehyde resin composition, a coating composition comprising the same, a coating layer obtained by curing the coating composition, and its application.

### 2. Description of the Prior Arts

Melamine-formaldehyde resin (MF) is a synthetic resin produced by hydroxymethylation of melamine and formaldehyde, followed by etherification with alcohols.

Because melamine-formaldehyde resin has good miscibility with host resins such as polyester resin, epoxy resin, acrylic resin, phenolic resin, or alkyd resin, it can be mixed with various host resins and optional additives to prepare a coating material. Moreover, a melamine-formaldehyde resin coating has good flame retardancy, heat resistance, water resistance, and insulation. It has been widely used in various products in construction, vehicles, canning, furniture, kitchen utensils, and other products.

However, the coating layer formed by the current commercially available melamine-formaldehyde resin coatings often has disadvantages such as excessive hardness, poor gloss, poor chemical resistance, and insufficient adhesion, so steel coils, vehicles, or canned products containing such coating layers have poor quality and performance, thereby limiting the application fields of melamine-formaldehyde resin coatings.

Therefore, there is still a need to improve the conventional melamine-formaldehyde resin in order to improve the quality and performance of its applied products.

### SUMMARY OF THE INVENTION

In view of the defects in the prior art, one of the objectives of this instant disclosure is to improve the conventional melamine-formaldehyde resin so that its coating layer can have excellent gloss.

Another objective of this instant disclosure is to improve the conventional melamine-formaldehyde resin so that its coating layer can have excellent chemical resistance.

Another objective of this instant disclosure is to improve the conventional melamine-formaldehyde resin so that its coating layer can have appropriate hardness.

Another objective of this instant disclosure is to improve the conventional melamine-formaldehyde resin so that its coating layer can have good adhesion.

To achieve the aforesaid objective, the instant disclosure provides a melamine-formaldehyde resin composition, wherein a Fourier transform infrared (FT-IR) spectrum of the melamine-formaldehyde resin composition has a first peak at 3334 cm⁻¹ to 3344 cm⁻¹ and a second peak at 1072 cm⁻¹ to 1074 cm⁻¹, and a ratio of an intensity of the first peak to an intensity of the second peak is less than or equal to 0.021.

By controlling the ratio of the intensity of the first peak to the intensity of the second peak in the FT-IR spectrum of the melamine-formaldehyde resin composition to be less than or equal to 0.021, which is equivalent to controlling the proportion of specific functional groups in the melamine-formaldehyde resin composition, the coating layer formed by curing the coating composition of the melamine-formaldehyde resin composition has excellent gloss, chemical resistance, adhesion, and hardness, thereby enhancing the overall performance of the coating layer and application products, and facilitating the expansion of the application fields of melamine-formaldehyde resin compositions.

According to the instant disclosure, in the FT-IR spectrum of the melamine-formaldehyde resin composition, the ratio of the intensity of the first peak to the intensity of the second peak may be, for example, 0.010, 0.011, 0.012, 0.013, 0.014, 0.015, 0.016, 0.017, 0.018, 0.019, 0.020, or 0.021, but not limited thereto, and the above-mentioned specific values may be used as endpoints of other numerical ranges. For example, in the FT-IR spectrum of the melamine-formaldehyde resin composition, the ratio of the intensity of the first peak to the intensity of the second peak may be greater than or equal to 0.010 and less than or equal to 0.021.

Preferably, the ratio of the intensity of the first peak to the intensity of the second peak may be less than or equal to 0.018. By lowering the ratio aforementioned, the gloss, the chemical resistance, the hardness, and the adhesion of the coating layer can be further significantly improved, thereby improving the overall performance of the coating layer.

Those skilled in the art can understand that the absorption peak(s) around 3334 cm⁻¹ to 3344 cm⁻¹ may correspond to active functional groups (for example, —NH₂ and —CH₂OH) of the melamine-formaldehyde resin composition. The intensity of the first peak at 3334 cm⁻¹ to 3344 cm⁻¹ may be, for example, 0.010, 0.011, 0.012, 0.013, 0.014, 0.015, 0.016, 0.017, 0.018, 0.019, 0.020, 0.021, 0.022, 0.023, or 0.024 arbitrary unit (a.u.), but not limited thereto, and the above-mentioned specific values may be used as endpoints of other numerical ranges. In one embodiment, the intensity of the first peak at 3334 cm⁻¹ to 3344 cm⁻¹ may be 0.010 a.u. to 0.024 a.u. In another embodiment, the intensity of the first peak at 3334 cm⁻¹ to 3344 cm⁻¹ may be 0.010 a.u. to 0.018 a.u.

The absorption peak(s) around 1072 cm⁻¹ to 1074 cm⁻¹ may correspond to ether functional groups (for example, —OCH₃) in the melamine-formaldehyde resin composition. The intensity of the second peak at 1072 cm⁻¹ to 1074 cm⁻¹ may be, for example, 0.80, 0.81, 0.82, 0.83, 0.84, 0.85, 0.86, 0.87, 0.88, 0.89, 0.90, 0.91, or 0.92 a.u., but not limited thereto, and the above-mentioned specific values may be used as endpoints of other numerical ranges. In one embodiment, the intensity of the second peak at 1072 cm⁻¹ to 1074 cm⁻¹ may range from 0.80 a.u. to 0.92 a.u. In another embodiment, the intensity of the second peak at 1072 cm⁻¹ to 1074 cm⁻¹ may range from 0.85 a.u. to 0.90 a.u.

According to the instant disclosure, a free formaldehyde content in the melamine-formaldehyde resin composition may be less than or equal to 0.093 weight percent (wt %), which means the melamine-formaldehyde resin composition of the instant disclosure can meet the industry's environmental protection requirements. The free formaldehyde content in the melamine-formaldehyde resin composition may be, for example, 0.020, 0.025, 0.030, 0.035, 0.040, 0.045, 0.050, 0.055, 0.060, 0.065, 0.070, 0.075, 0.080, 0.085, 0.090, 0.091, 0.092, or 0.093 wt %, but not limited thereto, and the above-mentioned specific values may be used as endpoints of other numerical ranges. In one embodiment, the free formaldehyde content in the melamine-formaldehyde resin composition may be 0.020 wt % to 0.093 wt %. In another embodiment, the free formaldehyde content in the melamine-formaldehyde resin composition may be 0.020 wt % to 0.090 wt %. In another embodiment, the free formaldehyde content in the melamine-formaldehyde resin composition may be 0.020 wt % to 0.070 wt %.

To achieve the aforesaid objective, the instant disclosure further provides a coating composition comprising a host resin and the aforementioned melamine-formaldehyde resin composition.

According to the instant disclosure, the host resin may be polyester resin, epoxy resin, acrylic resin, phenolic resin, or alkyd resin, but not limited thereto. The melamine-formaldehyde resin composition of this instant disclosure can be used in conjunction with various commercially available host resins as long as the two have good miscibility; there are no particular restrictions.

In the coating composition, the melamine-formaldehyde resin composition may be comprised in an amount of 10, 15, 20, 25, 30, or 35 parts by weight based on 100 parts by weight of the host resin, but not limited thereto, and the above-mentioned specific values may be used as endpoints of other numerical ranges. In one embodiment, the melamine-formaldehyde resin composition may be comprised in an amount of 10 parts by weight to 25 parts by weight based on 100 parts by weight of the host resin.

To achieve the aforesaid objective, the instant disclosure further provides a use of a coating composition. The use of a coating composition may be, for example, a method of preparing a coating material In one embodiment, the method comprises using the foresaid coating composition to prepare the coating material, and the coating material is a steel coil coating material, an automotive coating material, a can coating material, a wood coating material, or a leather coating material, but not limited thereto. In addition to the aforementioned application fields, the coating composition may be formulated into a water-based coating material and applied to various other products.

To achieve the aforesaid objective, the instant disclosure further provides a coating layer, which may comprise the aforementioned coating composition, and the coating layer is formed by curing the coating composition.

Preferably, the coating layer may exhibit a 60° gloss greater than or equal to 80 gloss units (GU). Specifically, the 60° gloss of the coating layer may be, for example, 80, 81, 82, 83, 84, 85, 86, 87, 88, 89, 90, 91, 92, 93, 94, 95, 96, 97, 98, 99, or 100 GU, but not limited thereto, and the above-mentioned specific values may be used as endpoints of other numerical ranges. More preferably, the 60° gloss of the coating layer may be greater than or equal to 90 GU. In the present specification, the 60° gloss of the coating layer is analyzed by ISO 2813:2014.

Preferably, the coating layer exhibits a pencil hardness that may be H to 3H. Specifically, the coating layer exhibits a pencil hardness that may be H, 2H, or 3H. In the present specification, the pencil hardness of the coating layer is analyzed by ISO 15184:2020.

Preferably, the coating layer exhibits an adhesion that may be 3B to 4B in a cross-cut test. More preferably, the coating layer exhibits an adhesion that may be 4B. In the present specification, the adhesion of the coating layer is analyzed by ISO 2409:2020.

Preferably, the coating layer may exhibit greater than 50 cycles, greater than 100 cycles, greater than 200 cycles, or greater than 300 cycles of abrasion resistance. The abrasion resistance of the coating layer is analyzed by ISO2812:2017. The more cycles of abrasion resistance a coating layer could withstand, the better chemical resistance it would possess.

### BRIEF DESCRIPTION OF THE DRAWINGS

FIG. 1 is a schematic flowchart for producing the melamine-formaldehyde resin compositions of Examples 1 to 5 and Comparative Examples 1 to 4.

FIGS. 2 to 9 are FT-IR spectra of the melamine-formaldehyde resin compositions of Examples 1 to 5 and Comparative Examples 1 to 3.

### DETAILED DESCRIPTION OF THE PREFERRED EMBODIMENTS

Hereinafter, several preparation examples and examples are described to illustrate the embodiments of a melamine-formaldehyde resin composition, coating composition comprising the same, and coating layer, and several comparative examples are provided for comparison. One person having ordinary skills in the art can easily realize the advantages and effects of the present specification from the following examples and comparative examples. It should be understood that the descriptions proposed herein are just preferable examples for the purpose of illustrations only, not intended to limit the scope of the instant disclosure. One person having ordinary skill in the art can make various modifications and variations to practice or apply the instant disclosure in accordance with the ordinary knowledge without departing from the spirit and scope of the instant disclosure.

### <Melamine-Formaldehyde Resin Compositions>

The melamine-formaldehyde resin composition could be produced through hydroxymethylation of melamine and formaldehyde under alkaline conditions, etherification with alcohols under acidic conditions, and then a purification step.

Optionally, more than one etherification and purification step may be performed during the process. For example, after the hydroxymethylation step, the etherification and purification steps could be repeated multiple times to prepare the melamine-formaldehyde resin composition. Moreover, a person of ordinary skills in the art can adjust the conditions, such as the dosage of melamine and formaldehyde, the temperature, pH value, and/or reaction time of hydroxymethylation and etherification, and the temperature and/or pressure of distillation in the purification step, depending on their needs to obtain the melamine-formaldehyde resin composition.

Optionally, in the manufacturing process, paraformaldehyde and formalin may be used alone or in combination as the formaldehyde reactants. When paraformaldehyde and formalin are used in combination as the formaldehyde reactants, the weight ratio of paraformaldehyde to formalin may be 1:1 to 9:1, but not limited thereto. Alternatively, the concentration of paraformaldehyde may be 30 wt % to 95 wt %, and its molecular formula may be HO—(CH₂O)ₙ—H, in which n may be 8 to 20, but not limited thereto. The formalin may be an aqueous solution of formaldehyde with a concentration of about 10 wt % to 45 wt %, but not limited thereto.

Optionally, the temperature for hydroxymethylation may range from 60° C. to 120° C., the pH value may range from pH 8 to pH 12, and the reaction time may range from 30 minutes to 120 minutes, but not limited thereto. Additionally, the temperature for etherification may range from 60° C. to 120° C., the pH value may range from pH 3 to pH 5, and the reaction time may range from 15 minutes to 90 minutes, but not limited thereto.

In addition, various methods such as atmospheric distillation, vacuum distillation, and/or filtration purification may be adopted for purification depending on the needs, but not limited thereto. In one of the embodiments, the purification step may include two stages of primary distillation and secondary distillation. Both the primary distillation and the secondary distillation may be carried out by atmospheric distillation, and the temperature and pressure conditions for both may be the same or different. Alternatively, the primary distillation may be carried out using atmospheric distillation, and the secondary distillation may be carried out by vacuum distillation, but not limited thereto. For atmospheric distillation, the temperature may range from 60° C. to 120° C., and the pressure may be about 760 torrs. For vacuum distillation, the temperature may range from 120° C. to 150° C., and the pressure may range from 60 torrs to 80 torrs, but not limited thereto.

For instance, the melamine-formaldehyde resin compositions in Examples 1 to 5 may be prepared using the following methods.

### Examples 1 to 5 (S1 to S5)

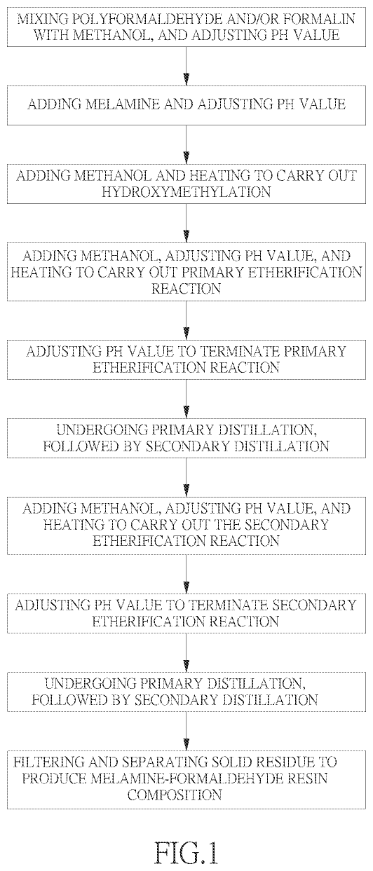

As shown in FIG. 1, the melamine-formaldehyde resin compositions in Examples 1 to 5 were prepared substantially using the following steps in sequence: raw material mixing, hydroxymethylation, primary etherification reaction, first recovery, secondary etherification reaction, second recovery, and filtration. The detailed steps were as follows.

First, paraformaldehyde and formalin, as shown in Table 1, were weighed along with 171 grams (g) of methanol. All of these were put into a reaction kettle, mixed, and stirred to form a mixed solution. Next, sodium hydroxide was added to adjust the pH value to pH 10.5±0.5. The temperature was then raised to 50° C. to allow the paraformaldehyde to completely dissolve, resulting in a transparent mixed solution. The paraformaldehyde and formalin used in this process were manufactured by Chang Chun Plastics Co., Ltd. The paraformaldehyde is of grade PR92T with a concentration of approximately 92 wt % and a molecular formula of HO—(CH₂O)ₙ—H, where n is 8 to 20. The formalin, of grade DFM37, is an aqueous solution of formaldehyde with a concentration of about 37 wt %.

Next, the transparent mixed solution was added with 106 g of melamine and then adjusted to a pH of 10.5±0.5 by adding sodium hydroxide. After that, 94 g of methanol was added to the mixed solution and then heated to 70° C. and kept for 90 minutes to carry out hydroxymethylation, in order to obtain a hydroxymethylation solution.

After that, the hydroxymethylation solution was added with 65 g of methanol and then adjusted to a pH of 4.0±0.5 by adding hydrochloric acid. Then, the hydroxymethylation solution was heated to 70° C. to carry out the primary etherification reaction for 40 minutes. Sodium hydroxide was then added to adjust the pH value to pH 9.5±0.5 to terminate the reaction and obtain a primary etherification solution.

After the primary etherification reaction was terminated, the primary etherification solution underwent primary distillation under the temperature and pressure conditions as shown in Table 1, followed by secondary distillation under the temperature and pressure conditions as shown in Table 1 to obtain a first recovery solution.

Subsequently, the first recovery solution was added with 270 g of methanol and then adjusted to a pH of 4.0±0.5 by adding hydrochloric acid. Then, the first recovery solution was heated to 70° C. to carry out the secondary etherification reaction for 20 minutes. Sodium hydroxide was then added to adjust the pH value to pH 9.5±0.5 to terminate the reaction and obtain a secondary etherification solution.

After the secondary etherification reaction was terminated, the secondary etherification solution underwent primary distillation under the temperature and pressure conditions as shown in Table 1, followed by secondary distillation under the temperature and pressure conditions as shown in Table 1 to obtain a second recovery solution. The temperature and pressure conditions set for the primary distillation in the second recovery step were the same as those in the first recovery step. Similarly, the conditions set for the secondary distillation in the second recovery step were also the same as those in the first recovery step.

At last, the second recovery solution was kept for 60 minutes, then filtered, and the solid residue was separated. Finally, the melamine-formaldehyde resin composition was obtained.

TABLE 1
weights of the paraformaldehyde and formalin, the temperature
and pressure used in the primary and secondary distillation
during the first and second recovery steps of the preparation
of the melamine-formaldehyde resin composition for Examples
1 to 5 (S1 to S5) and Comparative Examples 1 to 4 (C1 to C4).

| | | | Primary | | Secondary | |
|---|---|---|---|---|---|---|
| | | | Distillation | | Distillation | |
| | Weight (g) | | Temp. | Pressure | Temp. | Pressure |
| | Paraformaldehyde | Formalin | (□) | (torr) | (□) | (torr) |
| S1 | 238 | 0 | 98 | 760 | 140 | 60 |
| S2 | 214 | 24 | 98 | 760 | 135 | 60 |
| S3 | 190 | 48 | 98 | 760 | 135 | 60 |
| S4 | 190 | 48 | 98 | 760 | 130 | 60 |
| S5 | 238 | 0 | 80 | 80 | 130 | 80 |
| C1 | 143 | 95 | 80 | 80 | 130 | 80 |
| C2 | 143 | 95 | 80 | 80 | 140 | 80 |
| C3 | 210 | 0 | 98 | 760 | 140 | 60 |
| C4 | 143 | 95 | 98 | 760 | 140 | 60 |

### Comparative Examples 1 to 4 (C1 to C4)

The process of preparing the melamine-formaldehyde resin composition in Comparative Examples 1 to 4 was almost the same as that in Examples 1 to 5, except for the weights of paraformaldehyde and formalin, and the temperature and pressure during the primary and secondary distillation of the first and second recovery steps. The weights of paraformaldehyde and formalin, as well as the process conditions, are listed in Table 1.

It should be clarified that a serious self-polymerization reaction occurred during the preparation of the melamine-formaldehyde resin composition in Comparative Example 4. As a result, the fluidity of the product obtained in Comparative Example 4 was lost after the primary distillation in the first recovery step, which prevented the secondary etherification reaction. Consequently, the melamine-formaldehyde resin composition of Comparative Example 4 could not be analyzed for subsequent free formaldehyde content or be subjected to FT-IR analysis. Additionally, it could not be formulated into a coating composition or cured into a coating layer, making it impossible to measure the performance of the coating layer.

### Test Example 1: FT-IR Spectroscopy Analysis

The melamine-formaldehyde resin compositions of Examples 1 to 5 and Comparative Examples 1 to 3 were used as test samples directly. Each test sample was placed in a Fourier transform infrared spectrometer (FT-IR spectrometer, manufacturer: PerkinElmer, grade: Spotlight 200i), and measured using the attenuated total reflection (ATR) method. The absorbance spectrum was obtained from 4000 cm⁻¹ to 500 cm⁻¹ at a resolution of 1 cm⁻¹ over 12 cumulative scans, and the peak intensity was the absorbance of the absorption peak at the specified wavelength (arbitrary unit, a.u.).

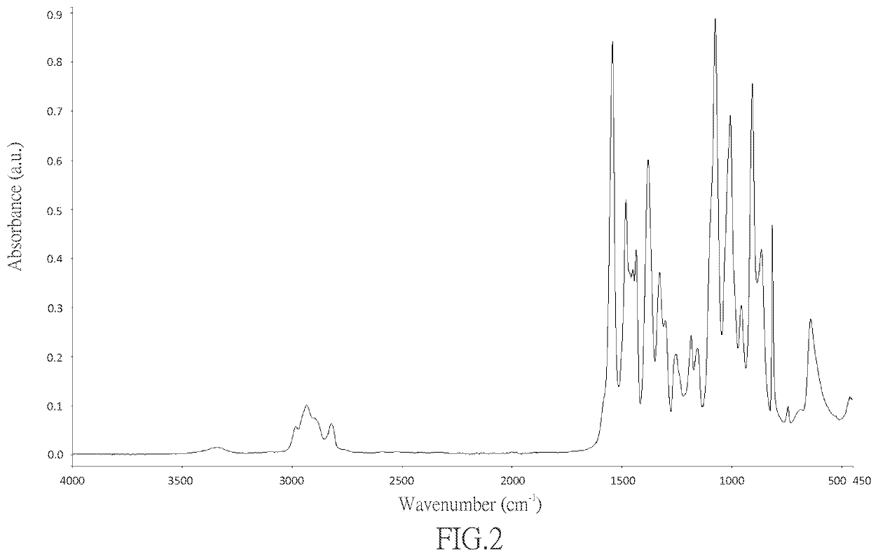

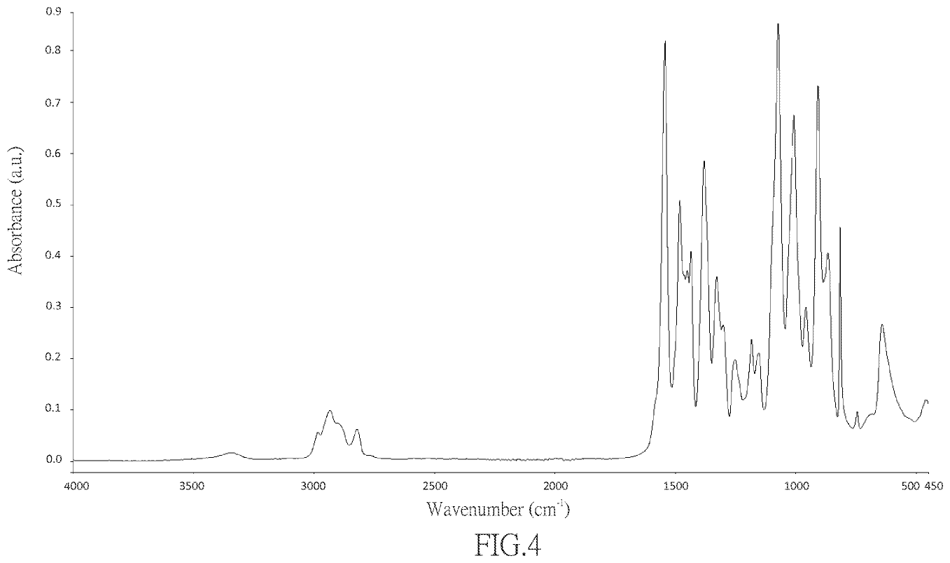

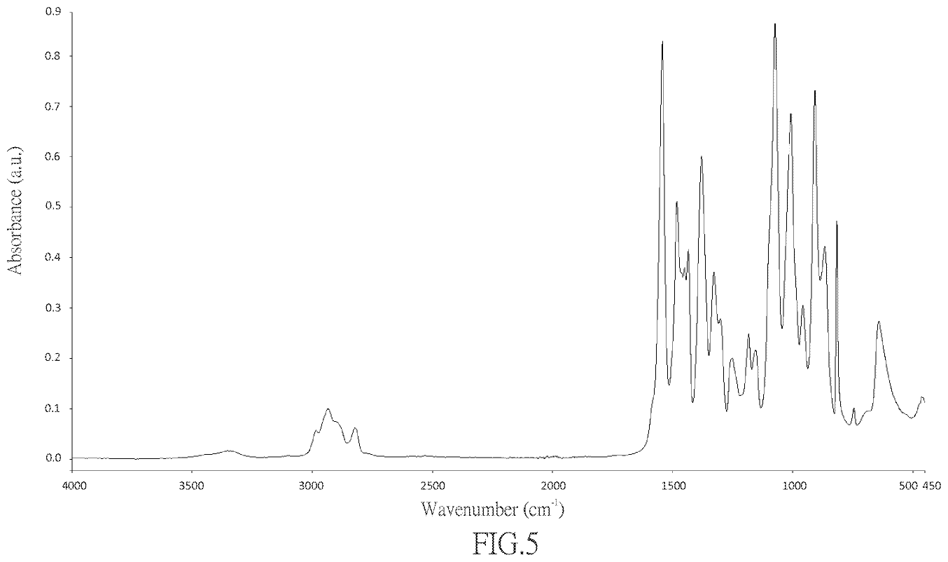

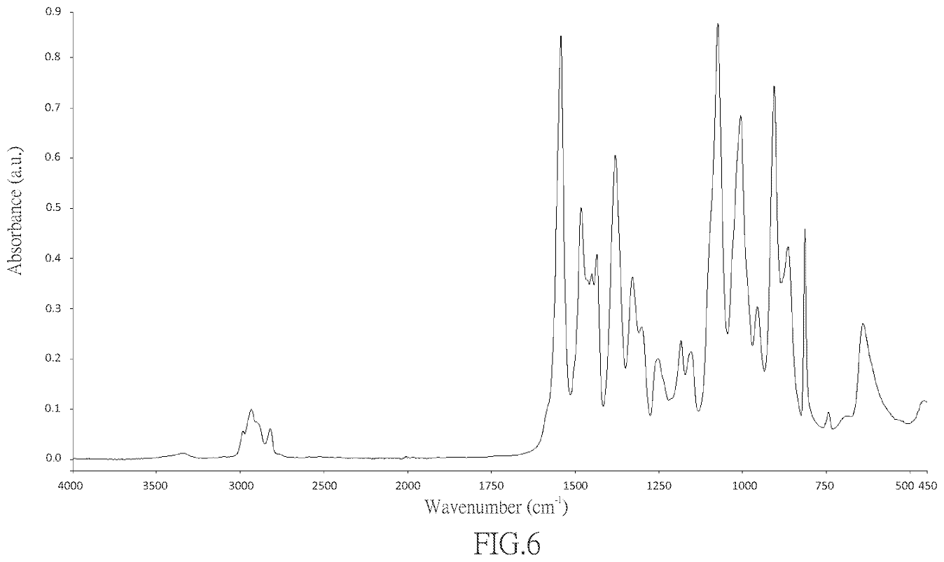

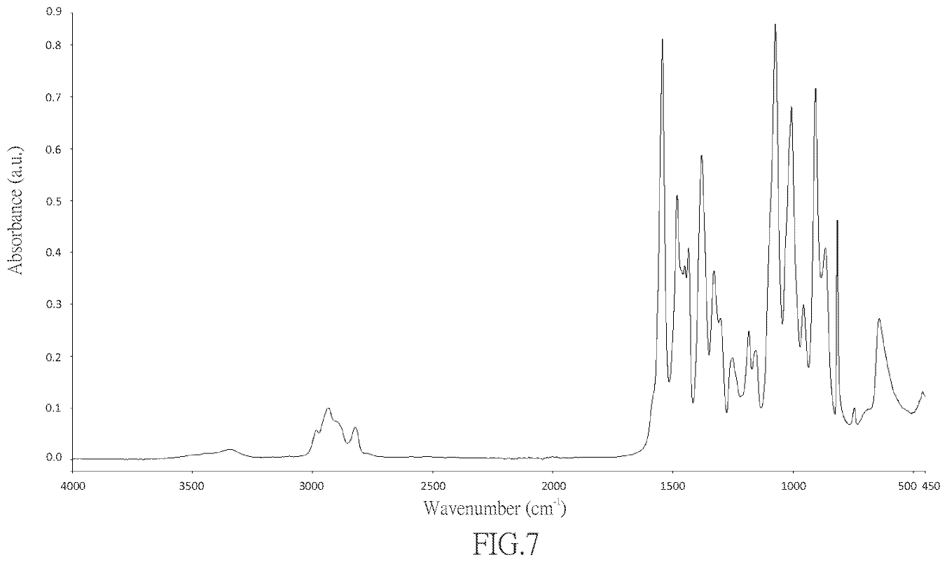

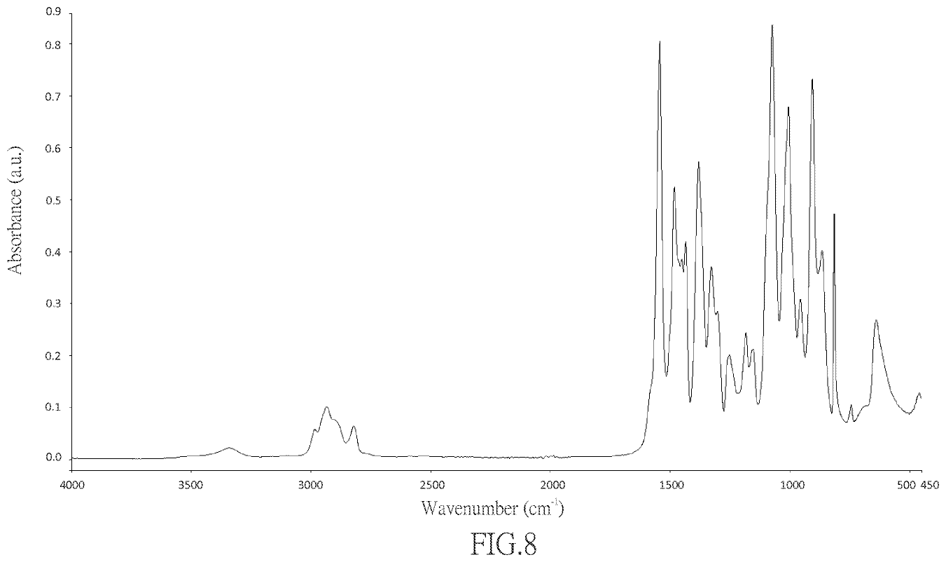

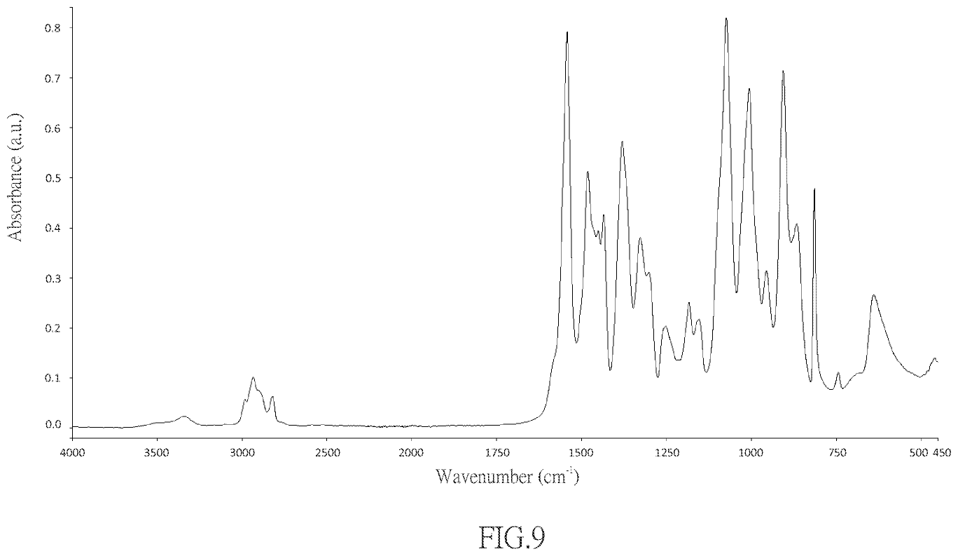

Following the aforementioned analytical method, the FT-IR spectra of melamine-formaldehyde resin compositions for Examples 1 to 5 and Comparative Examples 1 to 3 were measured and shown in FIGS. 2 to 9, respectively. In FIGS. 2 to 9, the absorption peak of active functional groups (such as —NH₂, —CH₂OH) could be observed at a wavenumber of about 3339±5 cm⁻¹, and its absorbance is also referred to as “the intensity of the first peak”; the absorption peak of the ether functional group (such as —OCH₃) could be observed at a wavenumber of about 1073±1 cm⁻¹, and its absorbance is also referred to as “the intensity of the second peak”. The intensity of the first peak and the intensity of the second peak are listed in Table 2 below, and the ratio of the intensity of the first peak to the second peak is listed in Table 2 and Table 4 below.

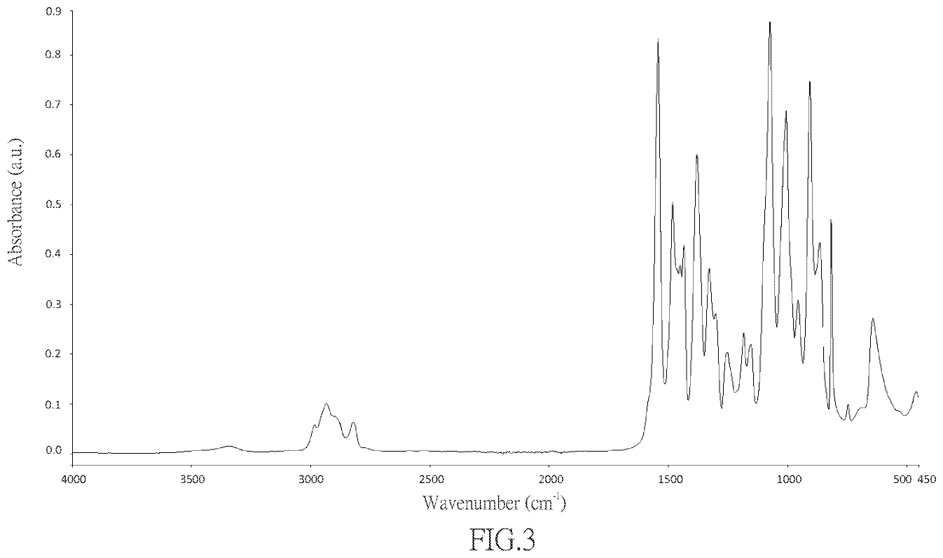

Taking FIG. 2 as an example for illustration, the absorption peaks of —NH₂ and —CH₂OH could be observed at wavenumbers from about 3335 cm⁻¹ to 3340 cm⁻¹, and the absorption peaks of —OCH₃ could be observed at wavenumbers from about 1073.00 cm⁻¹ to 1073.71 cm⁻¹. In FIGS. 3 to 9, the absorption peak positions of active functional groups (—NH₂, —CH₂OH) also fell within the wavenumber range of 3339±5 cm⁻¹, and the absorption peak positions of ether functional groups (—OCH₃) also fell within the wavenumber range of 1073±1 cm⁻¹.

TABLE 2
the intensity of the first peak (@3339 ± 5
cm⁻¹), the intensity of the second peak (@1073 ±
1 cm⁻¹), the ratio of the intensity of the first peak
to the intensity of the second peak, and the free formaldehyde
content of the melamine-formaldehyde resin compositions
in Examples S1 to S5 and Comparative Examples C1 to C4
were determined by FT-IR analysis.

| | | | Ratio of the | |
|---|---|---|---|---|
| | | | intensity of the | Free |
| | Intensity of | Intensity of | first peak to the | formaldehyde |
| | first peak | second peak | intensity of the | content |
| | (a.u.) | (a.u.) | second peak | (wt %) |
| S1 | 0.0151 | 0.8897 | 0.0169 | 0.040 |
| S2 | 0.0151 | 0.8665 | 0.0174 | 0.059 |
| S3 | 0.0166 | 0.8531 | 0.0195 | 0.041 |
| S4 | 0.0179 | 0.8571 | 0.0209 | 0.061 |
| S5 | 0.0121 | 0.8689 | 0.0139 | 0.093 |
| C1 | 0.0190 | 0.8480 | 0.0224 | 0.099 |
| C2 | 0.0220 | 0.8290 | 0.0265 | 0.093 |
| C3 | 0.0234 | 0.8205 | 0.0285 | 0.071 |

| | |
|---|---|
| C4 | Undetectable |

1 As shown in Table 2 and Table 4, the ratio of the intensity of the first peak at 3339±5 cm⁻¹ relative to the intensity of the second peak at 1073±1 cm⁻¹ of the melamine-formaldehyde resin composition in Examples 1 to 5 was less than or equal to 0.021, and specifically fell within the range from 0.010 to 0.021. However, the ratio of the intensity of the first peak at 3339±5 cm⁻¹ relative to the intensity of the second peak at 1073±1 cm⁻¹ of the melamine-formaldehyde resin composition in Comparative Examples 1 to 3 exceeded 0.022. It can be seen that the ratio of active functional groups (—NH₂, —CH₂OH) relative to the ether functional group (—OCH₃) in the melamine-formaldehyde resin compositions of Examples 1 to 5 was significantly different from that of Comparative Examples 1 to 3.

Additionally, the ratio of the intensity of the first peak at 3339±5 cm⁻¹ to the intensity of the second peak at 1073±1 cm⁻¹ of the melamine-formaldehyde resin compositions in Examples 1, 2, and 5 was less than or equal to 0.018 and specifically fell within the range of 0.010 to 0.018. The proportion of active functional groups relative to ether functional groups in Examples 1, 2, and 5 was significantly more different from that of Comparative Examples 1 to 3.

### Test Example 2: Free Formaldehyde Content Analysis

The melamine-formaldehyde resin compositions in Examples 1 to 5 and Comparative Examples 1 to 3 were used as test samples. After conducting a blank test and titration test, the volumes of hydrochloric acid standard solutions consumed in these two tests were recorded and substituted into the following formula to obtain the free formaldehyde content (unit: wt %) of each melamine-formaldehyde resin composition. The results are shown in Table 2 and Table 4.

$$FF ( \% ) = \frac{0.045 \times N \times ( B - A )}{S} \times 100 \%$$

In the above formula,
FF: free formaldehyde content;
A: the volume of the hydrochloric acid standard solution consumed in the blank test, unit: milliliter (ml);
B: the volume of the hydrochloric acid standard solution consumed in the titration test, unit: ml;
N: the normality of the hydrochloric acid standard solution, unit: mol/L;
S: the weight of the sample, unit: g;
0.045: the mass of formaldehyde equivalent to 1 ml of 1N hydrochloric acid standard solution.

### Blank Test:

50 ml of isopropanol was added into a conical flask. Then, 5 to 6 drops of bromocresol green indicator (BCG indicator) were added and titrated with 0.1 N hydrochloric acid (HCl) until the solution turned yellow-green. Next, 5 ml of 10% (w/v) ammonium chloride solution (NH₄Cl) and 5 ml of 1 N sodium hydroxide solution (NaOH) were added, and it was left to stand at 25±1° C. for 1 hour. After that, it was titrated with 1 N (substituted into the “N” of the above formula) hydrochloric acid standard solution until the solution turned yellow-green as the endpoint. The volume of hydrochloric acid standard solution consumed during the titration test was recorded as “B”.

### Titration Test:

5 g of the test sample (substituted into the “S” of the above formula) was added into a conical flask, which had been accurately weighed to the fourth decimal place, and the test sample was dissolved in 50 ml of isopropanol. Then, 5 to 6 drops of BCG indicator were added and titrated with 0.1 N HCl until the solution turned yellow-green. Next, 5 ml of 10% (w/v) NH₄Cl and 5 ml of 1 N NaOH were added, left to stand at 25±1° C. for 1 hour. After that, it was titrated with 1 N (substituted into the “N” of the above formula) hydrochloric acid standard solution until the solution turned yellow-green as the endpoint. The volume of hydrochloric acid standard solution consumed during the titration test was recorded as “A”.

As shown in Table 2 and Table 4, the free formaldehyde content in the melamine-formaldehyde resin compositions of Examples 1 to 5 was less than or equal to 0.093 wt %, which met environmental protection requirements. In particular, the free formaldehyde content in the melamine-formaldehyde resin compositions of Examples 1 to 4 fell within the range of 0.020 wt % to 0.070 wt %, which was more in line with environmental protection requirements. On the contrary, the content of free formaldehyde in the melamine-formaldehyde resin composition of Comparative Example 1 was as high as 0.099 wt %, which was not conducive to subsequent applications.

### <Coating Composition>

The melamine-formaldehyde resin compositions of Examples 1 to 5 and Comparative Examples 1 to 3 could be used as crosslinking agents and mixed with the host resin and other reagents, such as pigments, solvents, and additives (for example, catalysts, leveling agents, dispersants, anti-sediment agents, wetting agents, and defoaming agents), to prepare various color coating compositions.

For instance, the melamine-formaldehyde resin compositions of Examples 1 to 5 and Comparative Examples 1 to 3 were mixed with polyester resin, solvent, and catalyst to prepare the coating compositions of Examples 1A to 5A and Comparative Examples 1A to 3A, respectively.

### Examples 1A to 5A and Comparative Examples 1A to 3A

First, the polyester, titanium dioxide, and solvent were mixed according to the dosage as shown in Table 3 to prepare a color paste. Then, the color paste, polyester, crosslinking agent, catalyst, and solvent were mixed in the proportions as shown in Table 3. The crosslinking agent used was the melamine-formaldehyde resin composition of Examples 1 to 5 and Comparative Examples 1 to 3. By following these steps, the coating compositions of Examples 1A to 5A and Comparative Examples 1A to 3A were prepared (with a solid content of 64%).

TABLE 3
components, dosage, and remarks of the coating
compositions of Examples 1A to 5A (S1A to S5A)
and Comparative Examples 1A to 3A (C1A to C3A).

| | Component | Dosage | Remarks |
|---|---|---|---|
| Color | Polyester | 18.71 | Produced by Daily Polymer Corp. |
| paste | | parts by | |
| | | weight | |
| | Titanium | 28.78 | Produced by Ya Chung Industrial |
| | dioxide | parts by | Co., Ltd. |
| | | weight | |
| | Solvent | 19.18 | S-150/DBE/BCS, in which the |
| | | parts by | volume ratio of the three is 6:3:1; |
| | | weight | Grade: S-150 (solvent naphtha), |
| | | | produced by Lau Fong Lee Co., |
| | | | Ltd.; DBE (Dibasic Ester), |
| | | | produced by Neuto Chemical |
| | | | Corp.; BCS (Ethylene glycol |
| | | | monobutyl ether), produced by |
| | | | Chang Chun Plastics Co., Ltd. |
| Coating | Color | 66.67 | The detailed composition is as |
| composition | paste | parts by | described above, with a solid |
| | | weight | content of 60%. |
| | Polyester | 18.33 | Produced by Daily Polymer Corp. |
| | | parts by | The polyester in the coating |
| | | weight | composition has the same |
| | | | composition as the polyester in the |
| | | | color paste. |
| | Crosslinking | 5.67 | The melamine-formaldehyde resin |
| | agent | parts by | compositions were respectively |
| | | weight | taken from the Examples 1 to 5 |
| | | | and Comparative Examples 1 to 3. |
| | Catalyst | 0.48 | Grade: Nacure 2500; produced by |
| | | parts by | King Industries, Inc. |
| | | weight | |
| | Solvent | 8.85 | S-150/DBE/BCS, in which the |
| | | parts by | volume ratio of the three is 6:3:1. |
| | | weight | The solvent in the coating |
| | | | composition has the same |
| | | | composition as the solvent in the |
| | | | color paste. |

The only difference between the coating compositions of Examples 1A to 5A and Comparative Examples 1A to 3A was the source of the crosslinking agent (melamine-formaldehyde resin composition). The rest of the components, including polyester, titanium dioxide, catalyst, and solvent, are the same and prepared using the same composition and dosage as shown in Table 3. The melamine-formaldehyde resin compositions used in the coating compositions of Examples 1A to 5A and Comparative Examples 1A to 3A were respectively the melamine-formaldehyde resin compositions of Examples 1 to 5 and Comparative Examples 1 to 3.

### <Coating Layer>

The aforementioned coating composition could be applied to the substrate through a suitable coating method and formed into a coating layer by an appropriate curing method. The coating and curing methods were not particularly limited.

For instance, the coating layers in the following Examples 1B to 5B and Comparative Examples 1B to 3B were formed using the coating compositions of Examples 1A to 5A and Comparative Examples 1A to 3A through the methods described below.

### Examples 1B to 5B and Comparative Examples 1B to 3B

A galvanized steel plate was taken, and the coating compositions of Examples 1A to 5A and Comparative Examples 1A to 3A were separately applied onto the galvanized steel plate using a coating rod to form a wet film. The wet film thickness was controlled at 15 to 20 microns and was then cured at 250° C. for 120 seconds to obtain the coating layers of Examples 1B to 5B and Comparative Examples 1B to 3B.

The coating layers of Examples 1B to 5B and Comparative Examples 1B to 3B were formed by curing the coating compositions of Examples 1A to 5A and Comparative Examples 1A to 3A in sequence. As described above, it could be understood that the difference between the coating layers of Examples 1B to 5B and Comparative Examples 1B to 3B was only the source of the melamine-formaldehyde resin composition. The melamine-formaldehyde resin compositions used in the coating layers of Examples 1B to 5B and Comparative Examples 1B to 3B were respectively the melamine-formaldehyde resin compositions of Examples 1 to 5 and Comparative Examples 1 to 3.

### Test Example 3: Gloss Analysis

In Test Example 3, the coating layers of Examples 1B to 5B and Comparative Examples 1B to 3B described above were used as the test samples. The gloss of the coating layers at 60° was measured using a gloss meter (brand: BYK, grade: AG-4446) according to ISO 2813:2014 (4th edition, published in October 2014), and the results were recorded in gloss units (GU) as shown in Table 4.

As shown in Table 4, the 60° gloss of the coating layers of Examples 1B to 5B was greater than or equal to 80 GU, and specifically fell within the range of 80 GU to 100 GU. On the contrary, the 60° gloss of the coating layers of Comparative Examples 1B to 3B did not exceed 70 GU, which was significantly worse than those of Examples 1B to 5B.

In addition, the 60° gloss of the coating layers of Examples 1B, 2B, and 5B exceeded 90 GU. It could be seen that the coating layers of Examples 1B, 2B, and 5B exhibited even better gloss than Comparative Examples 1B to 3B. Therefore, the coating layers of Examples 1B, 2B, and 5B are particularly suitable for applications requiring higher gloss.

### Test Example 4: Chemical Resistance Analysis

Test Example 4 used the coating layers of the aforementioned Examples 1B to 5B and Comparative Examples 1B to 3B as test samples. A wear-resistant tester (brand: PROYES, grade: PAT-2011) was used to conduct the test according to ISO 2812:2017 (third edition, published in November 2017). The test samples and wiping paper containing methyl ethyl ketone (MEK) were fixed on the wear-resistant tester, and weights of a fixed weight were placed on the machine to apply equivalent force. The arm of the wear-resistant tester was then repeatedly operated to rub the surface of the test samples with the MEK wiping paper until the coating layer peeled off. The test was stopped, and the number of wear-resistant cycles, which represented an abrasion resistance, was recorded by the counter to evaluate the chemical resistance of the coating layer. The results are shown in Table 4.

As shown in Table 4, the coating layers of Examples 1B to 5B were able to withstand 50 or even 90 cycles of abrasion resistance by MEK. In contrast, the coating layers of Comparative Examples 1B to 3B could not withstand more than 50 cycles of abrasion resistance, and some even peeled off before 35 cycles. Therefore, it can be seen that the coating layers of Examples 1B to 5B had superior chemical resistance compared to those of Comparative Examples 1B to 3B.

In addition, the coating layers of Examples 1B, 2B, and 5B could withstand up to 300 cycles of abrasion resistance, indicating that Examples 1B, 2B, and 5B exhibited even better chemical resistance than Comparative Examples 1B to 3B. Therefore, these coating layers were particularly suitable for applications that required higher chemical resistance.

### Test Example 5: Pencil Hardness Analysis

Test Example 5 used the coating layers of Examples 1B to 5B and Comparative Examples 1B to 3B as test samples, and measured the pencil hardness of the coating layers using a pencil hardness tester (brand: TOKYO KAGAKU KIKAI) according to ISO 15184:2020 (3rd version, published in January 2020). The results are listed in Table 4. Pencil hardness levels ranged from soft to hard in the following order: 6B, 5B, 4B, 3B, 2B, B, HB, F, H, 2H, 3H, 4H, 5H, 6H, 7H, 8h, 9H, with HB representing medium hardness.

As shown in Table 4, the pencil hardness of the coating layers of Examples 1B to 5B ranged from H to 3H, whereas the pencil hardness of the coating layers of Comparative Examples 1B to 3B was 4H, indicating that the coating layers of Comparative Examples 1B to 3B were too hard and brittle. Compared to the coating layers of Examples 1B to 5B, the coating layers of Comparative Examples 1B to 3B were less suitable for subsequent applications.

In addition, the pencil hardness of the coating layers of Examples 1B, 2B, and 5B was all at the H level. This indicated that the coating layers of Examples 1B, 2B, and 5B had a softer surface characteristic compared to the coating layers of Comparative Examples 1B to 3B.

### Test Example 6: Cross-cut Adhesion Test

Test Example 6 used the coating layers of the previous Examples 1B to 5B and Comparative Examples 1B to 3B as test samples. A cross-cut tester (brand: TQC, grade: VF1846) was used to perform a cross-cut adhesion test on the coating layer surface according to ISO 2409:2020 (fifth edition, published in August 2020). The method involved making six parallel horizontal cuts and six parallel vertical cuts on the surface of the coating layer. Then, 25 squares with the same size and shape were marked on the coating layer surface. The adhesion of the coating layer was evaluated based on the percentage of the peeled area of the coating layer in each square.

If there was no detachment observed after the cross-cut adhesion test, and the detachment area was 0%, the coating layer was evaluated as 5B level, indicating excellent adhesion of the coating layer. If the detachment area was less than 5%, the coating layer was evaluated as 4B level. If the detachment area was between 5% and 15%, the coating layer was evaluated as 3B level. If the detachment area was between 15% and 35%, the coating layer was evaluated as 2B level. If the detachment area was between 35% and 65%, the coating layer was evaluated as 1B level. If the detachment area was greater than 65% after the cross-cut adhesion test, the coating layer was evaluated as 0B level, indicating extremely poor adhesion of the coating layer. The results obtained from the above analysis method are listed in Table 4.

As shown in Table 4, the cross-cut adhesion of the coating layers in Examples 1B to 5B was evaluated as 3B to 4B level. In contrast, the coating layers in Comparative Examples 2B to 3B had a larger area of detachment after the cross-cut adhesion test, resulting in a lower evaluation of 2B level, indicating that the adhesion of the coating layers in Comparative Examples 2B to 3B was significantly worse than that of the coating layers in Examples 1B to 5B.

TABLE 4
the ratio of the intensity of the first peak to the intensity of the second
peak, the Free formaldehyde content, and the implementation of the melamine-
formaldehyde resin composition used as a crosslinking agent in the FT-IR analysis
of the melamine-formaldehyde resin compositions of S1 to S5 and C1 to C4.
Additionally, the analysis results of 60° gloss, abrasion resistance,
pencil hardness, and cross-cut adhesion of the coating layers of Examples
1B to 5B (S1B to S5B) and Comparative Examples 1B to 4B (C1B to C4B).

| Melamine-formaldehyde | | | | | | | |
|---|---|---|---|---|---|---|---|
| resin composition | | | | | | | |
| | Ratio of | | Coating layer | | | | |
| | intensity of | FF | | | Abrasion | | |
| Sample | 1^{st} peak to | content | Sample | Gloss | resistance | Pencil | Cross-cut |
| No. | 2^{nd} peak | (wt %) | No. | (GU) | (times) | hardness | adhesion |
| S1 | 0.0169 | 0.040 | S1B | 95 | 300 | H | 4B |
| S2 | 0.0174 | 0.059 | S2B | 93 | 300 | H | 4B |
| S3 | 0.0195 | 0.041 | S3B | 84 | 117 | 3H | 3B |
| S4 | 0.0209 | 0.061 | S4B | 82 | 93 | 3H | 3B |
| S5 | 0.0139 | 0.093 | S5B | 90 | 300 | H | 4B |
| C1 | 0.0224 | 0.099 | C1B | 70 | 32 | 4H | 3B |
| C2 | 0.0265 | 0.093 | C2B | 66 | 13 | 4H | 2B |
| C3 | 0.0285 | 0.071 | C3B | 65 | 18 | 4H | 2B |

| | | | |
|---|---|---|---|
| C4 | Undetectable | C4B | Undetectable |

1 Furthermore, the coating layers in Examples 1B, 2B, and 5B had a detachment area of less than 5% after the cross-cut adhesion test, indicating a 4B level of adhesion. On the other hand, the coating layers in Comparative Examples 1B to 3B had a larger area of detachment after the cross-cut adhesion test. Therefore, the adhesion of the coating layers in Examples 1B, 2B, and 5B was all better than that of the coating layers in Comparative Examples 1B to 3B, which is more advantageous for future applications.

The above analysis results indicated that by controlling the ratio of the intensity of the first peak (@3339±5 cm⁻¹) to the intensity of the second peak (@1073±1 cm⁻¹) in the FT-IR spectrum of the melamine-formaldehyde resin compositions in Examples 1 to 5 to be less than or equal to 0.021, the proportion of active functional groups of the melamine-formaldehyde resin composition relative to the ether functional groups was controlled within a specific range. This technological approach can enhance the overall performance of coating compositions and coatings using melamine-formaldehyde resin composites as crosslinking agents. As a result, the coating layers of Examples 1B to 5B had a 60° gloss of 80 GU or above, an abrasion resistance of over 50 cycles, a pencil hardness of H to 3H, and a cross-hatch adhesion of 3B to 4B grade.

In contrast, the ratio of the intensity of the first peak to the intensity of the second peak in the FT-IR spectrum of the melamine-formaldehyde resin compositions in Comparative Examples 1 to 4 all exceeded 0.022, resulting in coating layers in Comparative Examples 1B to 3B having lower gloss, chemical resistance, and hardness than the coating layers in Examples 1B to 5B after using the melamine-formaldehyde resin composition as a crosslinking agent and curing it into a coating composition. The coating layers in Comparative Examples 1B to 3B had a 60° gloss of only 70 GU or below, an abrasion resistance of less than 35 cycles, a pencil hardness of 4H, and a 2B or 3B grade of cross-cut adhesion. In particular, the melamine-formaldehyde resin composition in Comparative Example 4 underwent severe self-polymerization during the process and could not be blended with other host resins to form a coating composition or even cured into a coating layer.

In summary, the instant disclosure controlled the ratio of the intensity of the first peak relative to the intensity of the second peak in the FT-IR spectrum of a melamine-formaldehyde resin composition to be less than or equal to 0.021. This allowed the coating layer cured by using this type of melamine-formaldehyde resin composition as a crosslinking agent to possess excellent gloss, excellent chemical resistance, appropriate hardness, and good adhesion. Therefore, the melamine-formaldehyde resin composition of the instant disclosure could be applied to steel coil coating material, automotive coating material, can coating material, wood coating material, and leather coating material in order to comprehensively enhance the overall performance of coating layers and application products.

Further analysis of the experimental results showed that when the ratio of the intensity of the first peak relative to the intensity of the second peak in the FT-IR spectrum of the melamine-formaldehyde resin composition was further controlled below 0.018 (for example, in Examples 1, 2, and 5), the coating layer cured by using it as a crosslinking agent (for example, in Examples 1B, 2B, and 5B) could simultaneously possess a 60° gloss of above 90 GU, an abrasion resistance of up to 300 cycles, a pencil hardness of H, and an adhesion of 4B. It can be seen that further lowering the relative ratio of the first and second peak intensities of the melamine-formaldehyde resin composition could better enhance the overall performance of the coating layer, making it possess even more excellent gloss, excellent chemical resistance, appropriate hardness, and excellent adhesion, and suitable for higher-specification application products.

What is claimed is:

1. A melamine-formaldehyde resin composition, wherein a Fourier transform infrared (FT-IR) spectrum of the melamine-formaldehyde resin composition has a first peak at 3334 cm⁻¹ to 3344 cm⁻¹ and a second peak at 1072 cm⁻¹ to 1074 cm⁻¹, and a ratio of an intensity of the first peak to an intensity of the second peak is less than or equal to 0.021.

2. The melamine-formaldehyde resin composition as claimed in claim 1, wherein the ratio of the intensity of the first peak to the intensity of the second peak is greater than or equal to 0.010 and less than or equal to 0.021.

3. The melamine-formaldehyde resin composition as claimed in claim 1, wherein the ratio of the intensity of the first peak to the intensity of the second peak is less than or equal to 0.018.

4. The melamine-formaldehyde resin composition as claimed in claim 1, wherein a free formaldehyde content in the melamine-formaldehyde resin composition is less than or equal to 0.093 wt %.

5. The melamine-formaldehyde resin composition as claimed in claim 2, wherein a free formaldehyde content in the melamine-formaldehyde resin composition is less than or equal to 0.093 wt %.

6. The melamine-formaldehyde resin composition as claimed in claim 3, wherein a free formaldehyde content in the melamine-formaldehyde resin composition is less than or equal to 0.093 wt %.

7. A coating composition comprising a host resin and the melamine-formaldehyde resin composition as claimed in claim 1.

8. The coating composition as claimed in claim 7, wherein the host resin is polyester resin, epoxy resin, acrylic resin, phenolic resin, or alkyd resin.

9. The coating composition as claimed in claim 7, wherein an amount of the melamine-formaldehyde resin composition is 10 parts by weight to 25 parts by weight based on 100 parts by weight of the host resin.

10. The coating composition as claimed in claim 8, wherein an amount of the melamine-formaldehyde resin composition is 10 parts by weight to 25 parts by weight based on 100 parts by weight of the host resin.

11. A method of preparing a coating material, comprising using the coating composition as claimed in claim 7 to prepare the coating material, wherein the coating material is a steel coil coating material, an automotive coating material, a can coating material, a wood coating material, or a leather coating material.

12. A coating layer, formed by curing the coating composition as claimed in claim 7.

13. The coating layer as claimed in claim 12, wherein the coating layer exhibits a 60° gloss of greater than or equal to 80 gloss units.

14. The coating layer as claimed in claim 12, wherein the coating layer exhibits a pencil hardness of H to 3H.

15. The coating layer as claimed in claim 12, wherein the coating layer exhibits an adhesion of 3B to 4B in a cross-cut test.

16. The coating layer as claimed in claim 12, wherein the coating layer exhibits greater than 50 cycles of abrasion resistance, which is analyzed by ISO2812:2017.

17. The coating layer as claimed in claim 13, wherein the coating layer exhibits greater than 50 cycles of abrasion resistance, which is analyzed by ISO2812:2017.

18. The coating layer as claimed in claim 14, wherein the coating layer exhibits greater than 50 cycles of abrasion resistance, which is analyzed by ISO2812:2017.

19. The coating layer as claimed in claim 15, wherein the coating layer exhibits greater than 50 cycles of abrasion resistance, which is analyzed by ISO2812:2017.
